(19) United States
(12) Patent Application Publication
(10) Pub. No.: US 2018/0231340 A1
(43) Pub. Date: Aug. 16, 2018

(54) ENHANCED THERMAL MANAGEMENT FOR DIRECTED ENERGY WEAPON

(71) Applicant: HAMILTON SUNDSTRAND CORPORATION, Windsor Locks, CT (US)

(72) Inventors: Rajiv Ranjan, South Windsor, CT (US); Charles E. Lents, Amston, CT (US); Brian St. Rock, Andover, CT (US)

(21) Appl. No.: 15/378,925

(22) Filed: Dec. 14, 2016

(51) Int. Cl. F41A 13/10; F41H 13/00; F25D 16/00

(52) U.S. Cl. CPC F41A 13/10; F05D 2260/601; F25D 16/00; F41H 13/0043

(57) ABSTRACT

Described herein is a thermal management system and methodology for a directed energy weapon on an aircraft. The thermal management system includes an evaporator in thermal communication with the directed energy weapon and operatively configured to cool the directed energy weapon by evaporating a refrigerant therein. The thermal management system also includes a refrigerant storage tank in fluid communication with the evaporator and a pump in fluid communication with the refrigerant storage tank and the evaporator configured to pump substantially liquid refrigerant to the evaporator.

### TECHNICAL FIELD

The subject matter disclosed herein relates to thermal management system for a directed energy weapon and, more specifically, a simplified two phase system for removing heat for a Directed Energy Weapon (DEW).

### BACKGROUND

Next generation aircraft are being designed with advanced weapons like laser based direct energy weapons (DEWs). DEWs (e.g., laser weapons) may require substantial cooling at the lowest possible weight for sustained operation. DEWs typically operate at low efficiency and thus, generate a large amount of heat during lasing (weapon firing) operation. DEW operation typically consists of relatively brief operating intervals, wherein relatively large “bursts” of cooling are required, interspersed with relatively long intervals in which the weapon is quiescent, and therefore, requires little or no cooling. This large thermal transient may drive the size of the thermal management system (TMS) used to control the thermal loading of the DEW Such requirements may result in a TMS that is significantly oversized, in-efficient and heavy for normal operating (non-lasing) modes, particularly for airborne applications. Therefore, a fast and efficient TMS is required to address the thermal load of a DEW and to protect onboard components from thermal transients.

Various systems are utilized in attempt to remove this heat load created by a DEW. However, the current proposed solutions either are of very large size & weight or consume coolant requiring regular charging. Examples of existing DEW heating/cooling solutions include:

1) Conventional refrigeration systems (e.g., Freon compression/expansion systems) that cool the system using electricity as the power source;

2) Refrigerant evaporative approaches; which consume refrigerant after every weapon firing event resulting into limitation of weapon use per flight as well as constant maintenance;

3) “Phase change” approaches, which use solidified Phase Change Materials (PCMs). A PCM material, such as ice, that melts to provide cooling, and other systems in which the PCM is regenerated “offline. Some PCM-cooled DEW systems are very complex, employing multiple fluids in chemical reactions; and

4) Multiple Phase Change Heat Exchanger units that are used sequentially, which effect the discharging of one unit while one or more additional exhausted units are being charged for re-use.

To date, systems employing the foregoing approaches are all relatively heavy and/or do not provide optimal operational flexibility. For example, many existing PCM systems prevent the use of different fluids for removing heat from the DEW vs. dissipating heat to other systems. The latter drawback is a relatively important one for laser weapons, wherein the major coolant use is for laser diodes, in which water is commonly used as the cooling medium of choice, whereas, the formation of ice requires the use of a material (e.g., a glycol solution) for cooling of the PCM that will remain a liquid below the freezing point of water. Additionally, these devices operate in either a “charge” mode (i.e., freezing the PCM using an external refrigeration system) or a “discharge” mode (i.e., thawing the PCM to cool the circulating DEW coolant).

### BRIEF SUMMARY

In one aspect described herein in an embodiment is a thermal management system for a directed energy weapon on an aircraft the thermal management system. The system includes an evaporator in thermal communication with the directed energy weapon and operatively configured to cool the directed energy weapon by evaporating a refrigerant therein, a refrigerant storage tank in fluid communication with the evaporator, the refrigerant storage tank configured to separate liquid refrigerant and vapor refrigerant, and a pump in fluid communication with the refrigerant storage tank and the evaporator and configured to pump substantially liquid refrigerant to the evaporator.

In addition to one or more of the features described above, or as an alternative, further embodiments may include a check valve in fluid communication with the pump and the evaporator operable to ensure that the substantially liquid refrigerant flows to the evaporator.

In addition to one or more of the features described above, or as an alternative, further embodiments may include a bypass valve operably connected in parallel to the evaporator.

In addition to one or more of the features described above, or as an alternative, further embodiments may include that the evaporator is a heat exchanger.

In addition to one or more of the features described above, or as an alternative, further embodiments may include that the refrigerant storage tank includes a separator section.

In addition to one or more of the features described above, or as an alternative, further embodiments may include that the separator section includes a coolant coil to condense vapor refrigerant.

In addition to one or more of the features described above, or as an alternative, further embodiments may include that the separator section includes a centrifugal separator.

In addition to one or more of the features described above, or as an alternative, further embodiments may include an air cycle machine in thermal communication with the refrigerant storage tank and wherein the refrigerant storage tank is configured to transfer heat to the air cycle machine.

In addition to one or more of the features described above, or as an alternative, further embodiments may include that the refrigerant is at least one of Ammonia, Freon, and CO2.

Also described herein on another embodiment is a method for removing heat from a directed energy weapon on an aircraft. The method including evaporating a refrigerant in an evaporator in thermal communication with the directed energy weapon and operatively configured to cool the directed energy weapon by evaporating a refrigerant therein, separating vapor refrigerant and liquid refrigerant in a refrigerant storage tank in fluid communication with the evaporator, condensing vapor refrigerant in the refrigerant storage tank, and pumping substantially liquid refrigerant from the refrigerant storage tank with a pump in fluid communication with the refrigerant storage tank and the evaporator.

In addition to one or more of the features described above, or as an alternative, further embodiments may include directing a flow of the substantially liquid refrigerant from the pump to the evaporator with a check valve in fluid communication with the pump and the evaporator operable

In addition to one or more of the features described above, or as an alternative, further embodiments may include a bypassing the evaporator via a valve operably connected in parallel to the evaporator.

In addition to one or more of the features described above, or as an alternative, further embodiments may include that the evaporating results in a phase change of the refrigerant in the heat exchanger.

In addition to one or more of the features described above, or as an alternative, further embodiments may include that the separating includes condensing the vapor refrigerant.

In addition to one or more of the features described above, or as an alternative, further embodiments may include that the separating includes centrifugally separating the vapor refrigerant and the liquid refrigerant.

In addition to one or more of the features described above, or as an alternative, further embodiments may include transferring heat from refrigerant in the refrigerant storage tank to an external system for subsequent dissipation.

In addition to one or more of the features described above, or as an alternative, further embodiments may include that the refrigerant is at least one of Ammonia, Freon, and CO2.

Technical effects of embodiments of the present disclosure include, but are not limited to a thermal management system and methodology for a directed energy weapon on an aircraft and more specifically, a simplified two phase system for removing heat for a Directed Energy Weapon (DEW).

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of embodiments are apparent from the following detailed description taken in conjunction with the accompanying drawings in which:

FIG. 1 depicts a thermal management system used to manage the heat created by a Directed Energy Weapon (DEW) in accordance with an embodiment;

FIG. 2 depicts an example refrigerant storage tank in accordance with an embodiment; and

FIG. 3 is a process flow diagram depicting the method of thermal management in accordance with an embodiment.

### DETAILED DESCRIPTION

The following description is merely illustrative in nature and is not intended to limit the present disclosure, its application or uses. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown.

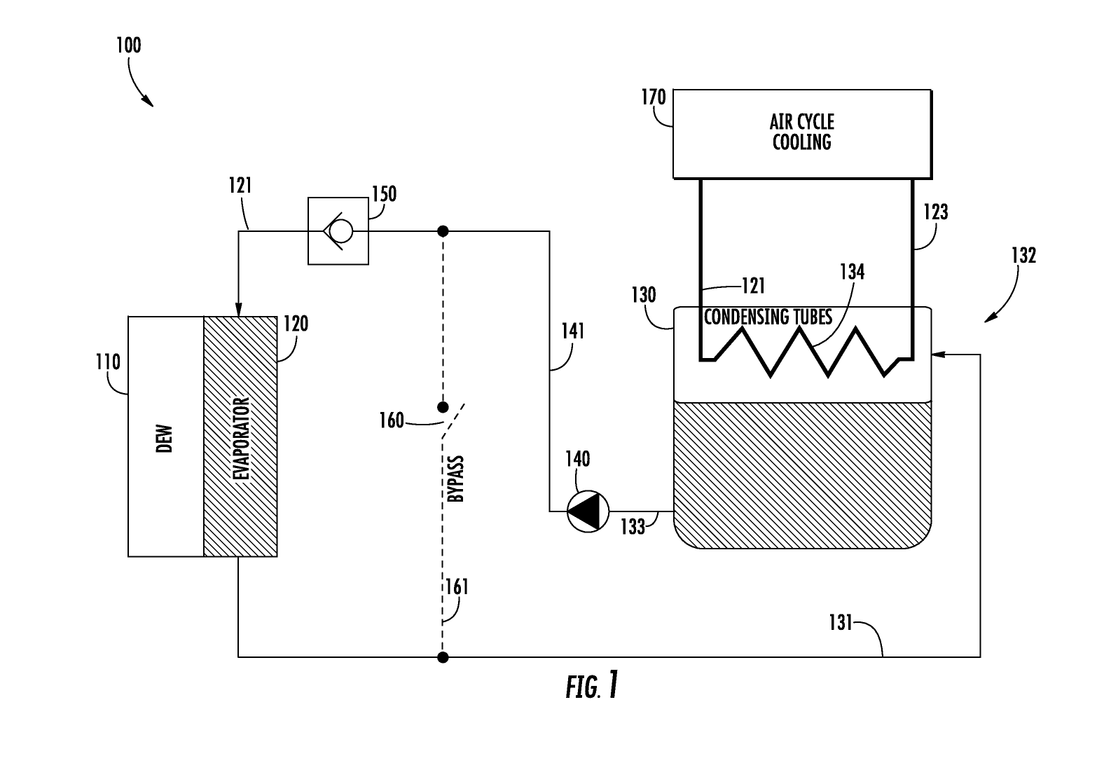

Turning now to FIG. 1, where a thermal management system (TMS) 100 is depicted. In one embodiment, the system 100 is used to manage the heat created by a Directed Energy Weapon (DEW) 110. The thermal management system 100 is configured of a simple refrigerant evaporation loop that addresses some of the complexities identified for existing cooling systems for directed energy weapons by employing a simple refrigerant based phase change cooling loop. Moreover the thermal management system 100 achieves the rapid, high capacity cooling capability of refrigerant evaporative systems but in a closed loop system allowing for the recovery of the refrigerant and reducing or avoiding maintenance intervals. In an embodiment the DEW 110 is in operational contact with an evaporator 120. The evaporator 120 is a heat exchanger configured to facilitate removing heat from the DEW 110, e.g., a phase change evaporator with a high heat flux load. such as, a plate fin cold plate, or jet impingement cold plate. In an embodiment a refrigerant (e.g. NH3, Freon, CO2) is circulated into a closed loop as shown at line 121 where it removes heat from the DEW 110 by evaporation and discharges heat back to a coolant coming from an aircraft cooling system (air cycle or vapor cycle) or secondary cooling 170.

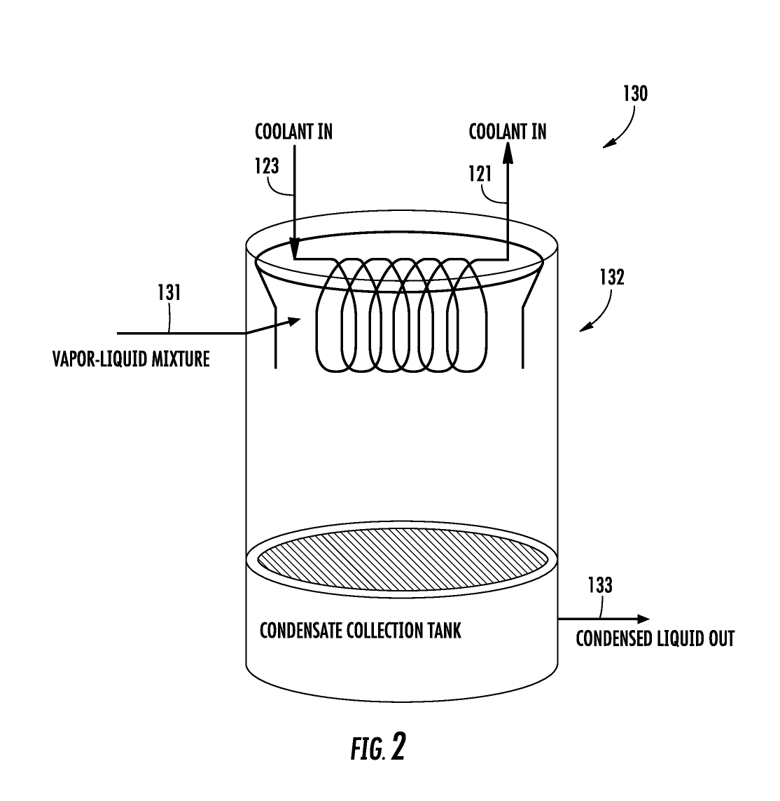

Turning now to FIG. 2 as well, an example of a refrigerant storage tank 130 in accordance with an embodiment is depicted. The refrigerant storage tank 130 which also acts a vapor-liquid separator and condenser and ensures that substantially liquid alone is returned to the evaporator 120. In an embodiment, when the combined vapor-liquid mixture returns via line 131 to the refrigerant storage tank 130 after cooling the DEW 110 at the evaporator 120 it is desirable to separate the vapor from the liquid. In order to accomplish this, the vapor is separated from the liquid in a separator section 134 of the refrigerant storage tank 130 employing a centrifugal motion of the mixture imparted by a tangential entry in to the tank. This motion causes the heavier liquid to be forced to the outside of the separator section 132 and then due to gravity fall and be collected in the bottom of the refrigerant storage tank 130. In addition, simultaneously vapor entering the separator section 132 impinges on a condensing coil 134 where a coolant is circulating via lines 121 and 123, where the vapor is at least partially condensed and then is collected in the bottom of the refrigerant storage tank 130. In an embodiment the refrigerant storage tank 130 and system 100 are of sufficient capacity to hold enough refrigerant to cool the DEW 110 for a selected operational cycle. It will be appreciated that the liquid portion of the refrigerant in the refrigerant storage tank 130 may vary during the operation of the DEW 110. For example, the level of the liquid refrigerant would decrease or be exhausted during the operational cycle of the DEW 110, while providing the needed cooling, but would increase or be fully replenished during a regeneration phase where cooling demands of the DEW 110 are reduced. Advantageously this approach of providing a system for rapidly cooling the DEW 110 for a selected duration, while more slowly dissipating the generated heat via other systems provides a simple and cost effective means for addressing the cooling requirements of the DEW 110. By leveling the DEW heat load to the time weighted average of the DEW on and DEW off heat load, the required cooling capacity of the aircraft cooling system 170 (air cycle of vapor cycle) is substantially reduced, and thus the aircraft cooling system's weight and peak power demand is reduced. The reduced peak power demand may also lead to lower peak power production capacity of components like electric generators, reducing their weight and increasing their part power efficiency.

Continuing with FIG. 1, in an embodiment, a pump 140 is employed to pump the condensed refrigerant as primarily liquid via line 133 from the refrigerant storage tank 132. The condensed refrigerant is directed into the cooling loop via line 141. A check valve 150 may be employed to direct the flow of the refrigerant to the evaporator 120 depending on the capabilities of the pump 140 and the degree of expansion in the evaporator 120 as the refrigerant is vaporized. In an embodiment, optionally a bypass line 161 with a bypass valve 160 may be employed to provide additional temperature control of the DEW 110, for example, when full capacity cooling is not required. It will be appreciated that the check valve 150, bypass valve 160, and pump 140 may be integral or separated as described. In an embodiment, a check valve 150 may be employed in the pump 140. In another embodiment, the check valve 150 and bypass valve 160 are combined in a single body.

The thermal management system 100 for a DEW 110 exhibits several advantages over existing thermal management systems. First, a two phase evaporative system provides for rapid heat removal. Likewise, such a system also facilitates rapid regeneration resulting into high weapon readiness/availability. Contrary to some refrigerant evaporative systems, the described embodiments present a regenerable system to reduce or avoid regular maintenance and “recharging”. Advantageously compared to other thermal management systems for DEWs, the described embodiments are relatively compact. For example, in one embodiment by reducing the peak loading by 30%, the thermal management system 100 may require only 50% of the volume of comparable systems. Moreover, the thermal management system of the described embodiments would be relatively light weight as it eliminates the need for heavy compressors and the like. Reductions in space and/or weight requirements are highly desired, particularly in airborne applications.

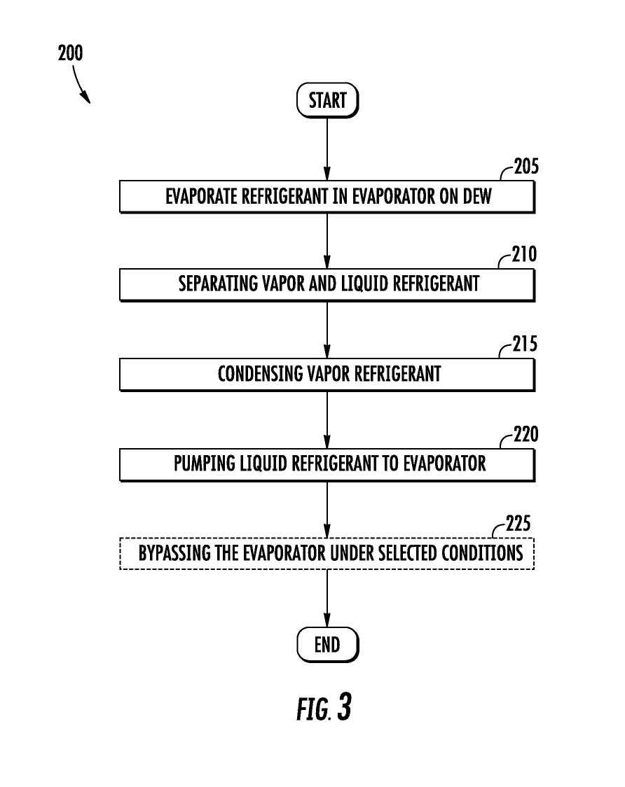

Turning now to FIG. 3, a process flow diagram depicting the method of thermal management 200 in accordance with an embodiment is provided. The method may be initiated as shown at process step 205 with evaporating a refrigerant in an evaporator operatively coupled to a DEW as described above. At process step 210 the method includes separating vapor refrigerant and liquid refrigerant in a refrigerant storage tank in fluid communication with the evaporator. In addition the separating of the vapor refrigerant and liquid refrigerant may include condensing vapor refrigerant in the refrigerant storage tank as depicted at process step 215. Continuing with FIG. 3, the method continues with pumping substantially liquid refrigerant from the refrigerant storage tank with a pump in fluid communication with the refrigerant storage tank and the evaporator as depicted by process step 220. Optionally, the process step may further include bypassing the evaporator under selected conditions as depicted at process step 225.

While the embodiments herein have been described with respect to a thermal management system for providing cooling to a directed energy weapon, most likely in an airborne application, it should be appreciated that the described embodiments are not limited as such. In fact, the described embodiments should be understood to cover any thermal management system application where a transient heat load with a short duration maximum load and a longer duration minimum load is encountered.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

What is claimed is:

1. A thermal management system for a directed energy weapon on an aircraft the thermal management system comprising:
an evaporator in thermal communication with the directed energy weapon and operatively configured to cool the directed energy weapon by evaporating a refrigerant therein;
a refrigerant storage tank in fluid communication with the evaporator, the refrigerant storage tank configured to separate liquid refrigerant and vapor refrigerant; and
a pump in fluid communication with the refrigerant storage tank and the evaporator and configured to pump substantially liquid refrigerant to the evaporator.

2. The thermal management system of claim 1, further including a check valve in fluid communication with the pump and the evaporator operable to ensure that the substantially liquid refrigerant flows to the evaporator.

3. The thermal management system according to claim 1, further including a bypass valve operably connected in parallel to the evaporator.

4. The thermal management system of claim 3, wherein the evaporator is a heat exchanger.

5. The thermal management system of claim 1, wherein the refrigerant storage tank includes a separator section.

6. The thermal management system of claim 5, wherein the separator section includes a coolant coil to condense vapor refrigerant.

7. The thermal management system of claim 5, wherein the separator section includes a centrifugal separator.

8. The thermal management system of claim 5, further including an air cycle machine in thermal communication with the refrigerant storage tank and wherein the refrigerant storage tank is configured to transfer heat to the air cycle machine.

9. The thermal management system of claim 1, wherein the refrigerant is at least one of Ammonia, Freon, and CO2.

10. A method removing heat from a directed energy weapon on an aircraft, the method comprising:
evaporating a refrigerant in an evaporator in thermal communication with the directed energy weapon and operatively configured to cool the directed energy weapon by evaporating a refrigerant therein;
separating vapor refrigerant and liquid refrigerant in a refrigerant storage tank in fluid communication with the evaporator;
condensing vapor refrigerant in the refrigerant storage tank; and
pumping substantially liquid refrigerant from the refrigerant storage tank with a pump in fluid communication with the refrigerant storage tank and the evaporator.

11. The method of claim 10, further including directing a flow of the substantially liquid refrigerant from the pump to the evaporator with a check valve in fluid communication with the pump and the evaporator operable

12. The method according to claim 10, further including a bypassing the evaporator via a valve operably connected in parallel to the evaporator.

13. The method of claim 10, wherein the evaporating results in a phase change of the refrigerant in the heat exchanger.

14. The method of claim 10, wherein the separating includes condensing the vapor refrigerant.

15. The method of claim 10, wherein the separating includes centrifugally separating the vapor refrigerant and the liquid refrigerant.

16. The method of claim 10, further including transferring heat from refrigerant in the refrigerant storage tank to an external system for subsequent dissipation.

17. The method of claim 10, wherein the refrigerant is at least one of Ammonia, Freon, and CO2.
